(19) United States
(12) Patent Application Publication
(10) Pub. No.: US 2023/0388875 A1
(43) Pub. Date: Nov. 30, 2023

(54) METHODS, APPARATUSES AND SYSTEMS FOR EPHEMERIS ASSISTED CELL SELECTION AND RESELECTION

(71) Applicant: ZTE CORPORATION, Shenzhen (CN)

(72) Inventors: Yuan GAO, Shenzhen (CN); He HUANG, Shenzhen (CN); Zhihong QIU, Shenzhen (CN); Nan ZHANG, Shenzhen (CN)

(73) Assignee: ZTE CORPORATION, Shenzhen (CN)

(21) Appl. No.: 18/203,231

(22) Filed: May 30, 2023

Related U.S. Application Data
(63) Continuation of application No. PCT/CN21/71823, filed on Jan. 14, 2021.

(51) Int. Cl. H04W 36/00; H04B 7/185; H04W 36/32

(52) U.S. Cl. CPC H04W 36/008357; H04B 7/18539; H04W 36/326

(57) ABSTRACT

Methods, apparatus and systems for cell selection or reselection based on ephemeris and/or configuration information are disclosed. In one embodiment, a method performed by a wireless communication device operating in a non-terrestrial network (NTN), the method including: obtaining configuration information associated with a plurality of candidate cells of the NTN, each of the plurality of candidate cells associated with a respective one of a plurality of candidate satellites; and based on the configuration information, adjusting a ranking of the plurality of candidate cells for cell selection or reselection.

### TECHNICAL FIELD

The disclosure relates generally to wireless communications and, more particularly, to methods, apparatuses and systems for performing ephemeris assisted cell selection and reselection.

### BACKGROUND

In a terrestrial network, the near-far effect allows a base station (e.g., gNB) to identify the location of a user equipment (UE) with reasonable accuracy. A user equipment (UE) that is “near” the base station has a relatively high received signal strength and quality (i.e., RSRP/RSRQ/SINR measured by UE is relatively high), whereas a UE that is “far” from the base station has a relatively low received signal strength. In current systems, the UE will reselect a new cell only if the following conditions are met: (i) the new cell is better than the serving cell according to predetermined cell reselection criteria during a time interval and (ii) more than one second has elapsed since the UE camped on a current serving cell. With this procedure, a cell selection and reselection procedure can be performed based on the RSRP/RSRQ measured by UE and cause the cell with the best signal strength measurements to be selected.

Non-terrestrial networks (NTN) are networks, or segments of networks, using an airborne or space-borne vehicle to provide wireless communication resources and services. In contrast to terrestrial networks, within cells of NTN's provided by satellites, the received signal strength and quality may not change significantly from the cell center to the cell edge. Accordingly, it may be difficult for a UE to accurately identify the edge of a cell and perform cell reselection when it reaches the edge of a cell. As a result, the UE may continue to camp on a first cell, instead of selecting a preferred second cell even when it reaches an edge of the first cell. Thus, existing methods of cell selection and reselection are not entirely adequate for performing cell selection or reselection in NTN systems.

### SUMMARY

The exemplary embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

In accordance with various embodiments, methods, apparatuses and systems for performing cell selection and/or reselection utilizing one or more predetermined configuration parameter and/or ephemeris information are described herein.

In some embodiments, a method performed by a wireless communication device, the method including: obtaining configuration information; based on the configuration information, selecting at least one criterion from among the following criteria: a cell with a shortest distance between a cell center and the wireless communication device; a cell with a shortest distance between a satellite and the wireless communication device; a cell with a longest valid time; a cell with a longest serving time; a cell with a longest remaining valid time; and a cell with a longest remaining serving time; ranking a plurality of candidate cells based at least in part on the selected at least one criterion; and selecting or reselecting one of the plurality candidate cells having a highest rank among the plurality of candidate cells.

In some embodiments, a method performed by a wireless communication device operating in a non-terrestrial network (NTN), the method including: obtaining configuration information associated with a plurality of candidate cells of the NTN, each of the plurality of candidate cells associated with a respective one of a plurality of candidate satellites; and based on the configuration information, adjusting a ranking of the plurality of candidate cells for cell selection or reselection.

In some embodiments, a non-transitory computer readable medium storing computer-executable instructions that when executed performs one or more of the methods described herein.

In some embodiments, a wireless communication device, includes: at least one processor configured to: obtain configuration information; based on the configuration information, selecting at least one criterion from among the following criteria: a cell with a shortest distance between a cell center and the wireless communication device; a cell with a shortest distance between a satellite and the wireless communication device; a cell with a longest valid time; a cell with a longest serving time; a cell with a longest remaining valid time; and a cell with a longest remaining serving time; ranking a plurality of candidate cells based at least in part on the selected at least one criterion; and selecting or reselecting one of the plurality candidate cells having a highest rank among the plurality of candidate cells.

In further embodiments, a wireless communication device, includes: at least one processor configured to: obtain configuration information associated with a plurality of candidate cells of the NTN, each of the plurality of candidate cells associated with a respective one of a plurality of candidate satellites; and based on the configuration information, adjusting a ranking of the plurality of candidate cells for cell selection or reselection.

### BRIEF DESCRIPTION OF THE DRAWINGS

Various exemplary embodiments of the present disclosure are described in detail below with reference to the following Figures. The drawings are provided for purposes of illustration only and merely depict exemplary embodiments of the present disclosure to facilitate the reader's understanding of the present disclosure. Therefore, the drawings should not be considered limiting of the breadth, scope, or applicability of the present disclosure. It should be noted that for clarity and ease of illustration these drawings are not necessarily drawn to scale.

FIG. 1 illustrates a NTN for a cell reselection method by a UE, in accordance with some embodiments of the present disclosure.

FIG. 2 illustrates a method to perform the cell reselection method of FIG. 1 by a UE, accordance with some embodiments of the present disclosure.

FIG. 3 illustrates a NTN for another cell reselection method by a UE, in accordance with some embodiments of the present disclosure.

FIG. 4 illustrates a method to perform the cell reselection method of FIG. 3 by the UE, accordance with some embodiments of the present disclosure.

FIG. 5 illustrates a NTN for yet another cell reselection method by a UE, in accordance with some embodiments of the present disclosure.

FIG. 6 illustrates a method to perform the cell reselection method of FIG. 5 by the UE, in accordance with some embodiments of the present disclosure.

FIG. 7 illustrates a NTN for a yet another cell reselection method by a UE, in accordance with some embodiments of the present disclosure.

FIG. 8 illustrates a method to perform the cell reselection method of FIG. 7 by the UE, in accordance with some embodiments of the present disclosure.

FIG. 9 illustrates a NTN for a yet another cell reselection method by a UE, in accordance with some embodiments of the present disclosure.

FIG. 10 illustrates a method to perform the reselection method of FIG. 9 by the UE, in accordance with some embodiments of the present disclosure.

FIG. 11 illustrates a block diagram of a network node configured to carry out the methods and techniques disclosed in the present disclosure, in accordance with some embodiments.

### DETAILED DESCRIPTION OF EXEMPLARY EMBODIMENTS

Various exemplary embodiments of the present disclosure are described below with reference to the accompanying figures to enable a person of ordinary skill in the art to make and use the present disclosure. As would be apparent to those of ordinary skill in the art, after reading the present disclosure, various changes or modifications to the examples described herein can be made without departing from the scope of the present disclosure. Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

A typical wireless communication terrestrial network includes at least one base station (BS) that provides geographical radio coverage, and at least one wireless user equipment device (UE) that can transmit and receive data within the radio coverage area. In the wireless communication network, a BS and a UE can communicate with each other via a communication link, e.g., via a downlink radio frame from the BS to the UE and via an uplink radio frame from the UE to the BS. The UE measures the signal strength and quality of the signals received from the BS, e.g., Reference Signal Received Power (RSRP), Reference Signal Received Quality (RSRQ) and signal to interference plus noise ratio (SINR).

As used herein, the terms “non-terrestrial network” or “NTN” refers to a wireless communication network that utilizes one or more airborne or spaceborne vehicles (referred to herein as “satellites”) for providing cellular coverage to one or more terminals, stations, mobile devices, user equipment (UE), etc. In some embodiments, one or more satellites of an NTN can provide partial or full base station functionality. In other words, at least a portion or all of the necessary hardware, software and/or firmware for performing the functions of a base station, as known in the art and further described herein, resides in the one or more satellites. In alternative embodiments, one or more satellites of the NTN can function merely as a relay node for receiving and then forwarding communications to and from a terrestrial base station.

As discussed herein, a “wireless communication node” can include, or be implemented as, a satellite, a terrestrial base station (BS), a next Generation Node B (gNB), and an E-UTRAN Node B (eNB), in accordance with the customary understanding of these terms in the art. Furthermore, as discussed herein, a “wireless communication device” can include, or be implemented as, a mobile terminal, a mobile station, a work station and a user equipment device (UE), in accordance with the customary understanding of these terms in the art. In the description of exemplary embodiments below, a satellite is described as an exemplary embodiment of a “wireless communication node” and a “user equipment device” or “UE” is described as an exemplary embodiment of a “wireless communication device.” Other terms used herein include, non-access stratum (NAS) signaling, new radio (NR), e.g. 5G NR, physical cell ID (PCI), radio access technologies (RAT), and system information block (SIB). It should be understood, however, that the scope of the present disclosure is not limited to these exemplary embodiments.

Various exemplary embodiments of the present disclosure are described in detail herein. It should be noted that the features of the embodiments and examples in the present disclosure may be combined with each other in any manner without conflict.

In some embodiments, methods for initial cell selection can improve upon conventional cell selection procedures, which include the following two procedures:

Procedure #1 is based on initial cell selection (no prior knowledge of which RF channels are NR frequencies). At a first operation, the UE can scan all RF channels in the NR bands according to its capabilities to find a suitable cell. Next, on each frequency, the UE needs only to search for the strongest cell, except for operation with shared spectrum channel access where the UE may search for the next strongest cell(s). Once a suitable cell can be found, this cell can be selected.

Procedure #2 is based on cell selection by leveraging stored information. This procedure can require stored information of frequencies and optionally also information on cell parameters from previously received measurement control information elements or from previously detected cells. Once the UE has found a suitable cell, the UE can select it. If no suitable cell can be found, the initial cell selection procedure in Procedure #1 can be started.

In accordance with various embodiments, a new cell selection procedure modifies and/or expands upon convention selection procedures, as described in further detail below. In further embodiments, after an initial cell selection procedure in accordance with conventional techniques, a new reselection procedure can be implemented, in accordance with various embodiments of the invention as described in further detail below.

In some embodiments, methods for cell reselection modify and improve upon conventional reselection techniques. In conventional cell reselection methods, the UE can only perform cell reselection evaluation for NR frequencies and inter-RAT frequencies that are given in system information and for which the UE has a priority provided. If threshServingLowQ is broadcast in system information and more than 1 second has elapsed since the UE camped on the current serving cell, cell reselection to a cell on a higher priority NR frequency or inter-RAT frequency than the serving frequency can be performed if:
A cell of a higher priority NR or EUTRAN RAT/frequency fulfils Squal>Thresh_{X, HighQ} during a time interval Treselection_{RAT}

Otherwise, cell reselection to a cell on a higher priority NR frequency or inter-RAT frequency than the serving frequency can be performed if:
A cell of a higher priority RAT/frequency fulfils Srxlev>Thresh_{X, HighP} during a time interval Treselection_{RAT}; and
More than 1 second has elapsed since the UE camped on the current serving cell.

If threshServingLowQ is broadcast in system information and more than 1 second has elapsed since the UE camped on the current serving cell, cell reselection to a cell on a lower priority NR frequency or inter-RAT frequency than the serving frequency can be performed if: the serving cell fulfils Squal<Thresh_{Serving, LowQ} and a cell of a lower priority NR or E-UTRAN RAT/frequency fulfils Squal>Thresh_{X, LowQ} during a time interval Treselection_{RAT}. Otherwise, cell reselection to a cell on a lower priority NR frequency or inter-RAT frequency than the serving frequency can be performed if:
The serving cell fulfils Srxlev<Thresh_{Serving, LowP} and a cell of a lower priority RAT/frequency fulfils Srxlev>Thresh_{X, LowP} during a time interval Treselection_{RAT}; and
More than 1 second has elapsed since the UE camped on the current serving cell.

Cell reselection to a higher priority RAT/frequency can take precedence over a lower priority RAT/frequency if multiple cells of different priorities fulfil the cell reselection criteria.

Cell reselection to a cell on an equal priority NR frequency can be based on ranking for intra-frequency cell reselection and R-criterion parameters. For example, the cell-ranking criterion Rₛ for serving cell and Rₙ for neighbouring cells is defined by:

Rₛ=Q_{meas,s}+Q_{hyst}−Qoffsetₜₑₘₚ

Rₙ=Q_{meas,n}−Qoffset−Qoffsetₜₑₘₚ

where:

| | |
|---|---|
| Qₘₑₐₛ | RSRP measurement quantity used in cell reselections. |
| Qoffset | For intra-frequency: Equals to Qoffset_{s,n}, if Qoffset_{s,n} |
| | is valid, otherwise this equals to zero. |
| | For inter-frequency: Equals to Qoffset_{s,n} plus |
| | Qoffset_{frequency}, if Qoffset_{s,n} is valid, otherwise |
| | this equals to Qoffset_{frequency}. |
| Qoffsetₜₑₘₚ | Offset temporarily applied to a cell as specified in |
| | TS 38.331 [3]. |

The cells can be ranked according to the R criteria specified above by deriving Q_{meas,n} and Q_{meas,s} and calculating the R values using averaged RSRP results.

If a parameter rangeToBestCell is not configured, the UE can perform cell reselection to the highest ranked cell. If rangeToBestCell is configured, then the UE can perform cell reselection to the cell with the highest number of beams above the threshold (i.e., absThreshSS-BlocksConsolidation) among the cells whose R value is within rangeToBestCell of the R value of the highest ranked cell. If there are multiple such cells, the UE can perform cell reselection to the highest ranked cell among them.

In all cases, the UE can reselect the new cell, only if the following conditions are met:
The new cell is better than the serving cell according to the cell reselection criteria specified above during a time interval Treselection_{RAT};
more than 1 second has elapsed since the UE camped on the current serving cell.

With the above procedures, conventional cell selection and reselection procedure can be performed based on the RSRP/RSRQ measured by UE and strongest cell will be selected. In some embodiments, after performing an initial cell selection of the present invention, the above-described conventional cell reselection procedures can be performed. In alternative embodiments, after conventional cell selection procedures, or new cell selection procedures of the invention, are performed, a new cell reselection procedure can be performed, in accordance with various embodiments of the invention, as described in further detail below.

As previously noted, for cells having a relatively large size (e.g. non-terrestrial network cells served by satellites), the received signal strength and quality (i.e., RSRP/RSRQ/SINR measured by UE) may not change significantly from the cell center to the cell edge. Thus, it may not be easy for a UE identify the edge of a cell and perform cell reselection when it reaches the edge of a cell. A method for ephemeris assisted cell selection and reselection is described in this disclosure to help UE perform cell selection and reselection.

In addition to the aforementioned procedures, a UE can receive ephemeris information and/or configuration information from the network and can perform cell selection or reselection based on the received ephemeris and configuration information of the cellular network. Various issues for this process are discussed below.

### Issue 1: Content of Ephemeris Information

Ephemeris information may include one or more of the following: Orbital parameters, orbital state vector information, cell information, beam information, association between the cell information and the satellite orbital parameters/orbital state vector information and association between the cell information and the beam. More specifically, the orbital parameters and include orbital and satellite related parameters. In some embodiments, examples of orbital parameters are Keplerian Orbit Elements (a, e, ω, Ω, i, M0), including Semi-major axis a [m], Eccentricity e Argument of periapsis ω [rad], Longitude of ascending node Ω [rad], Inclination i [rad], Mean anomaly M0=M(t0) [rad] at epoch t0 [JD]. The orbital parameters may also include one or more of the following: (1) baseline orbital parameters (2) adjustment to the orbital parameters when the satellite deviates from the planned orbits.

In some embodiments, orbital state vector information includes orbital position and velocity vectors (x, y, z, vx, vy, vz) at a reference time epoch to. In some other embodiments, cell information can include a physical cell ID (PCI) list consisting of one or more PCIs covered by a certain satellite. In yet further embodiments, beam information can include a number of beams for each satellite, boresight and/or 3 dB bandwidth of each beam.

### Issue 2: Provision of the Ephemeris Information

In some embodiments, for each satellite, the orbital parameters or orbital state vector of satellites or the cell information can be pre-configured to UE via NAS signaling or pre-configured in universal subscriber identification module (USIM). More specifically, the orbital parameters or orbital state vector of satellites can be pre-configured to a UE via NAS signaling or pre-configured in USIM while the cell information for each satellite can be provided via system information (e.g., system information block (SIB)) or dedicated radio-controlled clock (RRC) signaling. In some other embodiments, a satellite identity ID, defined or configured for each satellite with orbital parameters or orbital state vector, can also be pre-provisioned in a USIM or via NAS signaling. The cell information associated with each satellite ID can be provided via system information or dedicated RRC signaling.

In some embodiments, the baseline orbital parameters of satellites can be preconfigured to a UE via NAS signaling or pre-configured in a USIM, while the adjustments to the baseline orbital parameters along with the cell information are broadcast in system information. As previously noted, a satellite identity ID, defined or configured for each satellite with orbital parameters, can also be pre-provisioned in a USIM or via NAS signaling. The adjustments and cell information associated with each satellite ID can be provided via system information or dedicated RRC signaling. Moreover, the system information (or SIB) containing adjustments on satellite ephemeris and cell information can be configured as an on demand SIB which can be requested and acquired by UE in idle/inactive or connected mode.

In some embodiments, baseline orbital parameters and adjustments, along with the cell information can be broadcast in system information. In a first embodiment, the baseline orbital parameters and adjustments, along with the cell information are included in the same SIB. In a second embodiment, the baseline orbital parameters and cell information can be included in one SIB. A satellite identity ID can also be defined or configured for each satellite with baseline orbital parameters and cell information broadcast. The adjustments on orbital parameters associated with each satellite ID can be included in another SIB. In a third embodiment, the baseline orbital parameters can be included in one SIB. A satellite identity ID can also be defined or configured for each satellite with baseline orbital parameters broadcast. The adjustments on orbital parameters and cell information associated with each satellite ID can be included in another SIB. In a fourth embodiment, the baseline orbital parameters can be included in a first SIB. A satellite identity may also be defined or configured for each satellite with baseline orbital parameters broadcast. The adjustments associated with each satellite identity can be broadcast in a second SIB while the cell information associated with each satellite identity can be broadcast in a third SIB. All the SIBs mentioned above can be configured as on demand SIBs, which can be requested and acquired by a UE in idle, inactive or connected mode. In some embodiments, the adjustments to orbital parameters include adjustments to Keplerian Orbit Elements (e.g., Δa, Δe, Δω, ΔΩ, Δi, ΔM0). Because a satellite may not strictly follow the planned orbit and may deviate a little bit, these adjustments will inform the UE about how much the satellite has deviated.

Additionally, in some embodiments, orbital state vectors, along with the cell information can be broadcast in system information.

### Issue 3: Configuration Information

In some embodiments, configuration information can include a range to best cell for NTN (e.g., rangeToBestCellNTN), which can be used by a UE to identify candidate cells as possible reselection targets, in accordance with some embodiments. The neighbor cells can still be ranked based on the R-criterion, while the cells whose R value is within range of the R value of the highest ranked cell will be considered as candidate cells. This range (e.g., 2) can be provided by the configuration parameter RangeToBestCellNTN, which can be broadcast to the UE via system information by the NTN. Alternatively, the range to best cell can be defined as a fixed value in specifications and pre-configured in the UE.

In some embodiments, configuration information can include a threshold of a remaining valid time of a cell (e.g., Thresh_{RemainingVT}), with or without a specific offset for a cell that does not satisfy the threshold value. As used herein, a remaining valid time of a cell refers to a remaining amount of time that a UE will remain within the coverage of the cell. The threshold of the remaining valid time (e.g., Thresh_{RemainingVT}), and an offset or the reselection priority adjustment factor applied to a cell if a remaining valid time of the cell is less than Thresh_{RemainingVT}, can either be broadcast to the UE in system information or defined as a fixed value in a specification and pre-configured in the UE, in accordance with various embodiments.

In some embodiments, a threshold of the serving time of a cell (e.g., Thresh_{ST}), with or without a specific offset for a cell with valid time larger or smaller than the threshold can be deployed. As used herein, serving time of a cell refers to an amount of time a cell can provide service to the UE. In some embodiments, the serving time of a cell can be greater than the valid time of the cell since the serving time of a cell can be predicted by the UE based on the ephemeris information or the assistance information indicating the starting time and expire time of a cell before the UE enters the coverage of this cell.

### Issue 4: UE Behavior Upon Reception of the Configuration Information

In some embodiments, upon receiving a range to best cell for NTN (RangeToBestCellNTN) value, a UE can rank the neighbor cells based on the R-criterion, while the cells whose R value is within range to best cell in NTN of the R value of the highest ranked cell can be considered as candidate cells. The UE can then perform cell reselection to one or more criteria including: (i) a cell with shortest distance between the cell center and the UE; (ii) a cell with the shortest distance between the satellite and the UE; and/or (iii) a cell with longest valid/serving time or remaining valid/serving time. In some embodiments, the configuration information can also include an indication of which one or more criteria should be selected for cell ranking for selection or reselection. For example, the configuration information can include RangeToBestCellNTN and an indication that candidate cells should be ranked based on at least criterion (i), as described above. In other embodiments, upon receiving a particular threshold value (e.g., RangeToBestCellNTN), the UE can be pre-configured to selected one or more predetermined criteria for ranking candidate cells for selection and/or reselection. In some embodiments, the distance between cell center and the UE, distance between the satellite and the UE, valid/serving time and remaining valid/serving time can be calculated by the UE using ephemeris information or assistance information indicating the starting time and/or the expire time obtained by the UE.

In some embodiments, upon receiving a threshold of the remaining valid time Thresh_{RemainingT} of a cell, a UE can derive that a remaining valid time of the serving cell or a neighbor cell is below or above the Thresh_{RemainingT}. In some embodiments, a UE can consider a serving cell or a neighbor cell with a remaining valid time shorter than the Thresh_{RemainingVT} to be the lowest priority. In further embodiments, if a threshold (e.g., Thresh_{RemainingVT}) is satisfied (or not satisfied) new adjustment factors, referred to herein as CellSpecificReselectionPriority and CellSpecificReselectionSubPriority, can be added or subtracted to conventional priority factors CellReselectionPriority and CellReselectionSubPriority. For example, the new adjustment factors can be predetermined and set by the network to increase the priority of cells satisfying a threshold, or decrease the priority of cells that fail to satisfy a threshold to arrive at an absolute priority value for the cell. For example, depending on whether a specific threshold is satisfied or not satisfied, the absolute priority of a cell can be configured to be (CellReselectionSubPriority+CellReselectionPriority+CellSpecificReselectionPriority), (CellReselectionSubPriority+CellReselectionPriority+CellSpecificReselectionSubPriority), or (CellReselectionSubPriority+CellReselectionPriority+CellSpecificReselectionPriority+CellSpecificReselectionSubPriority), where the new adjustment factors can be configured to positive or negative and either increase or decrease the priority of the cell.

Similarly, in some embodiments, for the case when a reselection priority adjustment factor (e.g. CellReselectionPriorityOffset or CellReselectionSubPriorityOffset), for the frequency in which cells with remaining valid time shorter than the threshold is deployed, is configured, the absolute priority of the concerned carrier can be (CellReselectionSubPriority+CellReselectionPriority−CellReselectionPriorityOffset), (CellReselectionSubPriority+CellReselectionPriority−CellReselectionSubPriorityOffset), or (CellReselectionSubPriority+CellReselectionPriority−CellReselectionSubPriorityOffset−CellReselectionSubPriorityOffset). In some embodiments, CellReselectionPriorityOffset and CellReselectionSubPriorityOffset are adjustment factors that are determined by the network to be applied when one or more thresholds or criteria are not satisfied (or satisfied), wherein the adjustment factor is applied to a particular frequency (e.g., channel) and all cells operating in the particular frequency. In contrast, the cell specific adjustment factors CellSpecificReselectionPriority and CellSpecificReselectionSubPriority, described above, can be applied only to a particular cell, in accordance with some embodiments.

In a further embodiment, the configuration information can include an offset Qoffset_{RemainingT} to applied for ranking a cell. In some embodiments, when the offset Qoffset_{RemainingT} (e.g. with a positive value) is configured together with the Thresh_{RemainingVT}, the cell cell-ranking criterion Rₛ for a serving cell and Rₙ for neighboring cells can be defined below with Qoffset_{RemainingT} introduced to lower the rank of the serving cell or a neighbor cell with remaining time lower than the Thresh_{RemainingT}:

Rₛ=Q_{meas,s}+Q_{hyst}−QoffSetₜₑₘₚ−QoffSet_{RemainingT}

Rₙ=Q_{meas,n}−Qoffset−Qoffsetₜₑₘₚ−Qoffset_{RemainingT}

In another embodiments, upon receiving a threshold of the remaining valid time Thresh_{RemainingVT} of a cell, only cells with remaining valid time longer than the Thresh_{RemainingVT} would be considered in cell selection and reselection. For example, a T criterion can be defined as follows: The cell selection time criterion T is fulfilled when:

T_{Remaining}>Thresh_{RemainingVT},

where T_{Remaining} is the remaining valid time of the cell. Cells with T criterion fulfilled will be considered during cell selection and reselection procedure while other cells will be excluded. In some embodiments, the configuration parameter T_{Remaining} can be broadcast in system information, derived from ephemeris information, or derived based on the expire time of a certain cell broadcast in system information.

In further embodiments, the UE can perform ranking of all cells that fulfil a predetermined cell selection criterion S and the time criterion T. In some embodiments, upon receiving a threshold of the serving time Thresh_{ServingT} of a cell, a UE can evaluate whether the serving time of the serving cell or a certain neighbor cell is longer than the Thresh_{ServingT} or not to decide whether to adjust the ranking or priority levels of cells in accordance with various embodiments.

For example, in some embodiments, a UE can consider the serving cell or a neighbor cell with valid or serving time longer than Thresh_{ServingT} to be the highest priority. In other embodiments, for the case when a reselection priority adjustment factor (e.g. CellSpecificReselectionPriority or CellSpecificReselectionSubPriority) per cell is configured, the absolute priority of the concerned cell can be (CellReselectionSubPriority+CellReselectionPriority+CellSpecificReselectionPriority), (CellReselectionSubPriority+CellReselectionPriority+CellSpecificReselectionSubPriority), or (CellReselectionSubPriority+CellReselectionPriority+CellSpecificReselectionPriority+CellSpecificReselectionSubPriority), where the new adjustment factors can be configured to positive or negative and either increase or decrease the priority of the cell depending on whether the serving cell or a neighbor cell has a valid or serving time longer than Thresh_{ServingT}.

Similarly, in further embodiments, for the case when a reselection priority adjustment factor (e.g. CellReselectionPriorityOffset or CellReselectionSubPriorityOffset), for the frequency in which cells with serving time longer than the threshold is deployed, is configured, the absolute priority of the concerned carrier can be (CellReselectionSubPriority+CellReselectionPriority+CellReselectionPriorityOffset), CellReselectionPriorityOffset), (CellReselectionSubPriority+CellReselectionPriority+CellReselectionSubPriorityOffset), or (CellReselectionSubPriority+CellReselectionPriority+CellReselectionSubPriorityOffset+CellReselectionSubPriorityOffset), where the new adjustment factors can be configured to be positive or negative and either increase or decrease the priority of the concerned carrier depending on whether the serving cell or a neighbor cell has a valid or serving time longer than Thresh_{ServingT}.

In accordance with various embodiments, the parameters in the aforementioned paragraph may be configured by the network or may be predetermined in a specification. In the first case, the network can configure these parameters for load balancing, for example, and the values can be determined via network implementation, which transmits the parameters in a radio interface. If the network desires the UE to perform cell selection or reselection with more consideration on the distance to cell center/satellite, the valid time or serving time, the network can configure a larger value of these adjustments, in accordance with some embodiments.

In another embodiment, for the case when a offset Qoffset_{ServingT} (e.g. with a positive value) is configured together with the Thresh_{ServingT}, the cell cell-ranking criterion Rₛ for serving cell and Rₙ for neighbouring cells will be defined below with Qoffset_{ServingT} introduced to improve the rank of the erving cell or a neighbour cell with serving time longer than the Thresh_{ServingT}.

Rₛ=Q_{meas,s}+Q_{hyst}−Qoffsetₜₑₘₚ+Qoffset_{ServingT}

Rₙ=Q_{meas,n}−Qoffset−Qoffsetₜₑₘₚ+Qoffset_{ServingT}

In yet another embodiment, upon receiving a threshold of the serving time or valid time Thresh_{ServingT} of a cell, only cells with remaining valid time longer than the Thresh_{RemainingVT} would be considered in cell selection and reselection. For example, a T criterion can be defined as follows:
The cell selection time criterion T is fulfilled when:

T_{Serving}>Thresh_{ServingT}

where T_{Serving} is the serving time of a cell. The parameter T_{Serving} can be broadcast in system information, derived from the ephemeris or derived based on the expire time of a certain cell broadcast in system information. Cells with T criterion and S-criterion fulfilled will be considered during cell selection and reselection procedure while other cells will be excluded and a UE can perform ranking of all cells that fulfill the cell selection criterion S and time criterion T during cell reselection procedure.

### Issue 5: Derivation of the Distance to Cell Center/Satellite, the Serving Time or the Remaining Valid Time

In one or more embodiments, (1) a UE can derive the distance to cell center/satellite, the serving time or the remaining valid time upon reception of the ephemeris information; (2) a UE can derive the distance to cell center/satellite, the serving time or the remaining valid time upon reception of the configuration information; (3) a distance to cell center can be derived from the ephemeris information (e.g. orbital parameters/orbital state vector, cell information, beam information, association between the cell information and satellite/beam information); (4) distance to satellite can be derived from the ephemeris information; (5) a valid time/serving time or remaining valid/serving time can be derived based on the ephemeris and the beam information; (6) a valid/serving time or remaining valid/serving time of a cell is broadcast from the network (e.g., NTN); and/or (7) a valid/serving time or remaining valid/serving time of a cell can be derived based on the start time and/or expire time of a cell broadcast from the network.

### Example Scenario 1

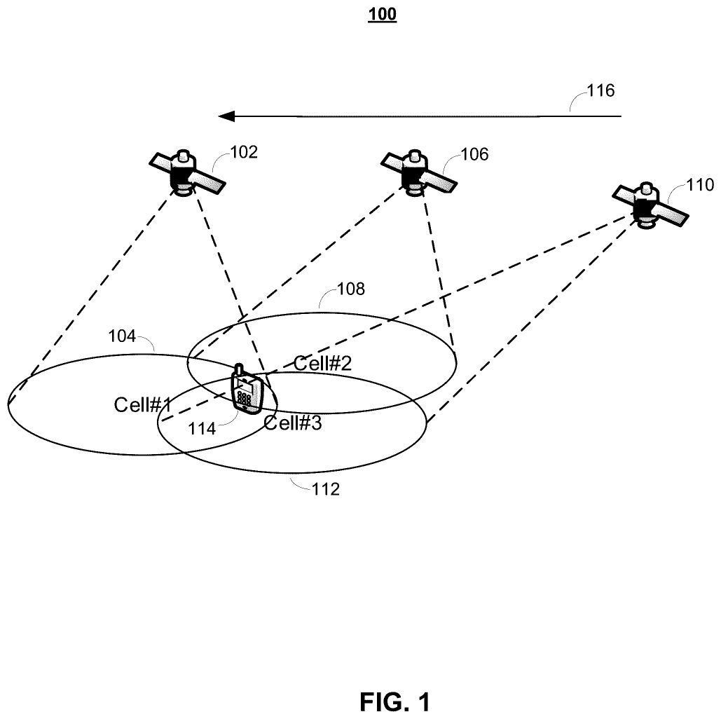

FIG. 1 illustrates an NTN 100 in which a cell reselection method can be performed by a UE 114, in accordance with some embodiments of the present disclosure. NTN 100 comprises satellite 102, satellite 106 and satellite 110 that respectively provide cellular communication services to Cell #1 104, Cell #2 108 and Cell #3 112. As illustrated, UE 114 is located within the boundaries of Cell #1 104, Cell #2 108 and Cell #3 112. It can be assumed that UE 114 is now camping on Cell #1 104 and is moving toward the edge of Cell #1 104, in which case a reselection to either Cell #2 108 or Cell #3 110 should be considered. It is assumed that NTN 100 comprises non-terrestrial information and can comprise terrestrial information. Arrow 116 indicates a direction that the satellites are moving.

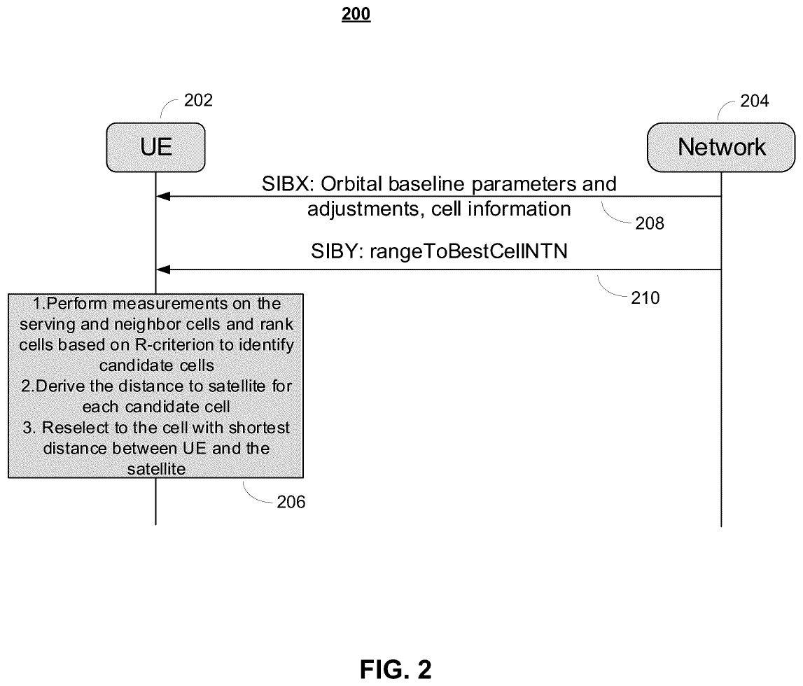

FIG. 2 illustrates a diagram of a method 200 implemented between a UE 202 and a network node 204 (e.g., a satellite) for performing a cell reselection procedure 206, in accordance with some embodiments of the present disclosure. As illustrated, while camping on Cell #1 104, a UE 202 can receive the ephemeris information (e.g., orbital baseline parameters and adjustments) via a first system information block, SIBX 208 broadcast by the network node 204. In some embodiments, the orbital baseline parameters can contain one or more of the Keplerian Orbit Elements (a, e, ω, Ω, i, M0), including Semi-major axis a [m], Eccentricity e

Argument of periapsis ω [rad] , Longitude of ascending node Ω [rad], Inclination i [rad], Mean anomaly M0=M(t0) [rad] at epoch t0 [JD], along with the adjustments of these parameters when the satellite deviates from the planned orbits, which can be used by UE to derive the real-time location of a satellite. The cell information associated with each satellite can also be provided.

Next, the UE 202 can receive a second system information block, SIBY 210, broadcast by the network node 204, in which a configuration parameter RangeToBestCellNTN is broadcast. After receiving SIBX and SIBY, as described above, the UE 202 performs reselection process 206. In a first operation, the UE 202 can perform measurements on neighbor cells and rank the cells based on R-criterion and identity candidate cells whose R value is within RangeToBestCellNTN of the R value of the highest ranked cell, i.e., Cell #2 108 and Cell #3 112. In some embodiments, this ranking can be in accordance with conventional techniques utilizing the following formulas and parameters:

Rₛ=Q_{meas,s}+Q_{hyst}−Qoffsetₜₑₘₚ

Rₙ=Q_{meas,n}−Qoffset−Qoffsetₜₑₘₚ

Based on the ranking, candidate cells can be determined. For example, if the rank of a best cell is 10 and the RangeToBestCellNTN value received by the UE 202 is 2, the UE will select all neighbor cells with a ranking of 8 or higher as candidate cells for possible reselection.

In a second operation, based on an association between satellite (e.g., ephemeris information) and the cell information, which can be provided in SIBX, for example, the UE 202 can identify the satellite covering each candidate cell and the location of these satellites, i.e., the location of satellite 106 and satellite 110 of FIG. 1. The UE 202 can then estimate the distance between itself and the satellite 106 and satellite 110 covering each candidate cell (i.e., cell #2 108 and cell #3 112). Finally, the UE 202 performs cell reselection to another cell (i.e., cell #2 108) with the shortest distance between the UE and the satellite.

### Example Scenario 2

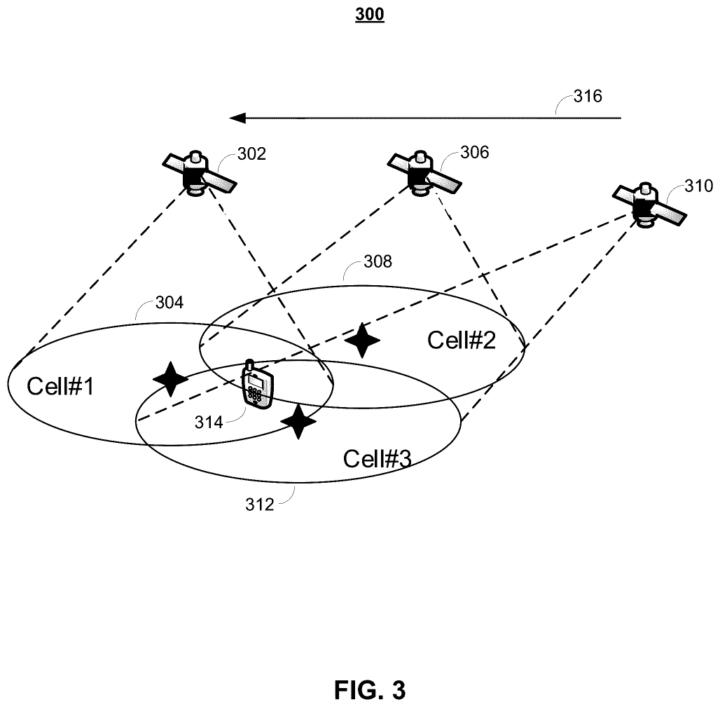

FIG. 3 illustrates an NTN 300 in which a cell reselection method performed by a UE 314 can be implemented, in accordance with some embodiments of the present disclosure. The NTN 300 comprises satellite 302, satellite 306 and satellite 310 that respectively provide cellular communication services to Cell #1 304, Cell #2 308 and Cell #3 312. As illustrated, UE 314 is located within the boundaries of Cell #1 304, Cell #2 308 and Cell #3 312. It can be assumed that UE 314 is now camping on Cell #1 304 and is moving toward the edge of Cell #1 304, in which case a reselection to connect to either Cell #2 308 or Cell #3 310 should be considered. Arrow 316 indicates a direction that the satellites are moving.

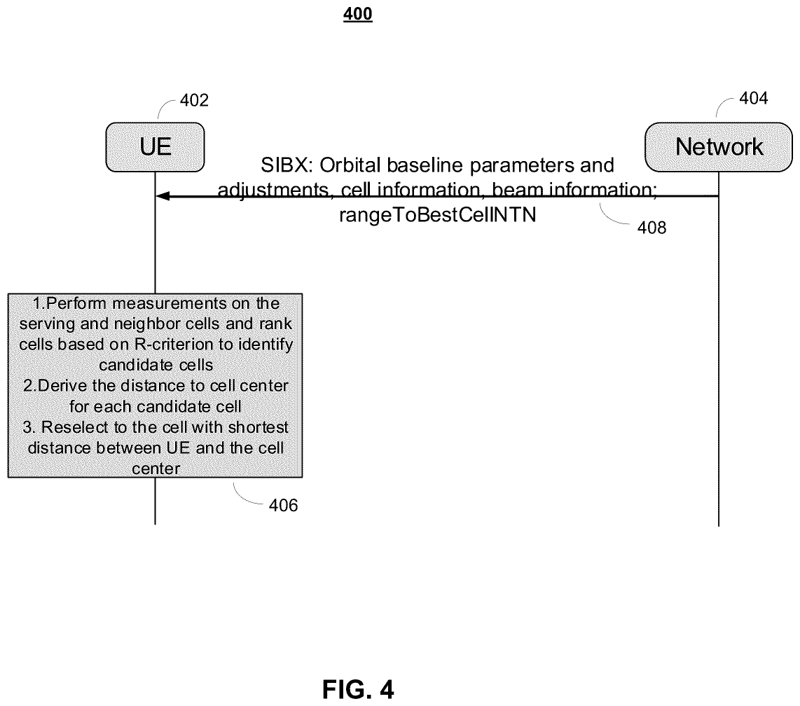

FIG. 4 illustrates a diagram for performing a method 400 implemented between a UE 402 and a network node 404 (e.g., a satellite) for performing a cell reselection procedure 406, in accordance with some embodiments of the present disclosure. As illustrated, while camping on Cell #1 304, UE 402, can receive ephemeris information (i.e., orbital baseline parameters and adjustments) via SIBX 408. In accordance with various embodiments, SIBX 408 can contain one or more of the following: (i) orbital baseline parameters contain the Keplerian Orbit Elements (a, e, ω, Ω, i, M0), including Semi-major axis a [m], Eccentricity e Argument of periapsis ω [rad] , Longitude of ascending node Ω [rad], Inclination i [rad], Mean anomaly M0=M(t0) [rad] at epoch t0 [JD], along with the adjustments of these parameters when the satellite deviates from the planned orbits, which can be used by UE 402 to derive the real-time location of a satellite (ii) beam information (e.g. number of beams for each satellite, boresight and/or 3 dB bandwidth of each beam) can also be broadcast to UE 402; and/or (iii) cell information associated with each satellite or beam can also be broadcast to UE 402 to derive the coverage of a cell and the location of the cell center. In addition to ephemeris information, SIBX 408 can also include configuration parameters such as RangeToBestCellNTN, as described above.

After receiving SIBX 408, the UE 402 can perform the cell reselection procedure 406. At a first operation, the UE 402 performs measurements on neighbor cells and can rank the cells based on R-criterion and can identity candidate cells whose R value is within RangeToBestCellNTN of the R value of the highest ranked cell, i.e., Cell #2 308 and Cell #3 310. In some embodiments, this ranking can be performed in accordance with conventional ranking methods utilizing the following formulas and parameters:

Rₛ=Q_{meas,s}+Q_{hyst}−Qoffsetₜₑₘₚ

Rₙ=Q_{meas,n}−Qoffset−Qoffsetₜₑₘₚ

Next, at operation 2, based on the association between satellite/beam and the cell information, UE 402 can identify coverage and cell center of each cell. UE 402 can then estimate the distance between itself and the cell center. Finally, the UE 402 will perform cell reselection to the cell (i.e., Cell #3 312) with the shortest distance between the UE and the cell center.

### Example Scenario 3

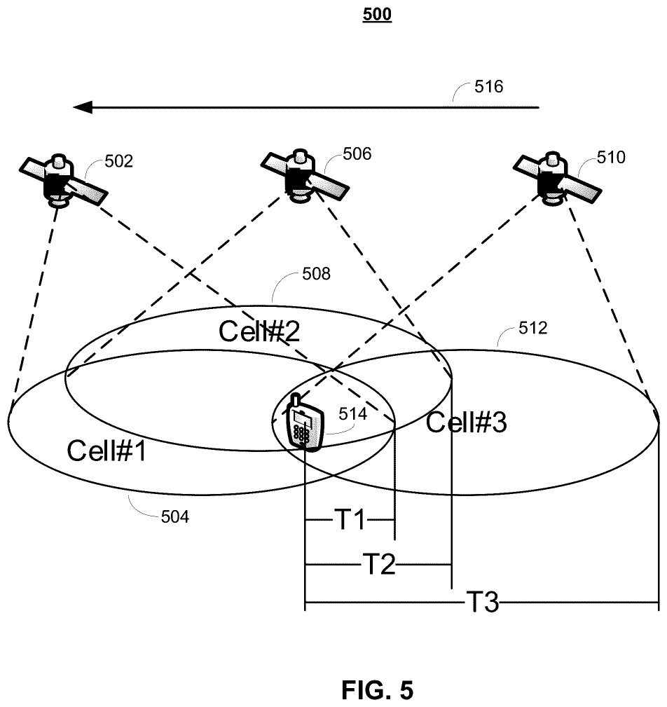

FIG. 5 illustrates a NTN 500 for performing yet another cell reselection method by a UE 514, in accordance with some embodiments of the present disclosure. The NTN 500 comprises satellite 502, satellite 506 and satellite 510 that respectively provide cellular communication services to Cell #1 504, Cell #2 508 and Cell #3 512. As illustrated, UE 514 is located within the boundaries of Cell #1 504, Cell #2 508 and Cell #3 512. It can be assumed that UE 514 is now camping on Cell #1 504 and is moving toward the edge of Cell #1 504, in which case a reselection to connect to either Cell #2 508 or Cell #3 510 should be considered. As illustrated, T1 represents a valid time of operation for UE 514 in Cell #1 504, T2 represents a valid time of operation for UE 514 in Cell #2 508, and T3 represents a valid time of operation for UE 514 in Cell #3 512. Per FIG. 5, T3 represents the longest valid time of operation. Arrow 516 indicates a direction that the satellites are moving.

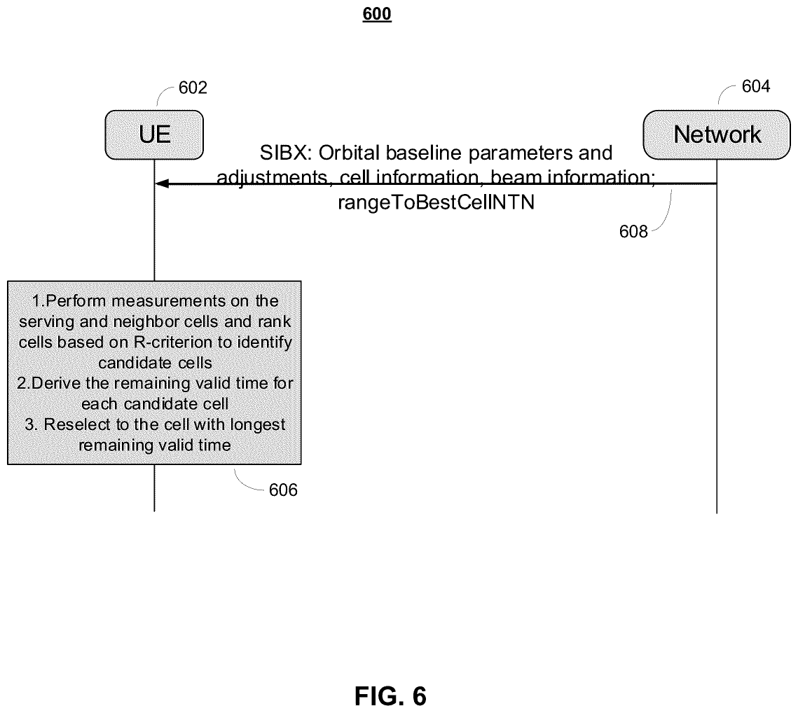

FIG. 6 illustrates a diagram of a method 600 implemented between a UE 602 and a network node 604 (e.g., a satellite) for performing a cell reselection procedure 606, in accordance with some embodiments of the present disclosure. As illustrated, while camping on Cell #1 504, UE 602 can receive ephemeris information (i.e., orbital baseline parameters and adjustments) via SIBX 608 transmitted by the network node 604. SIBX 608 can contain one or more of the following: (i) orbital baseline parameters can contain the Keplerian Orbit Elements (a, e, ω, Ω, i, M0), including Semi-major axis a [m], Eccentricity e Argument of periapsis ω [rad] , Longitude of ascending node Ω [rad], Inclination i [rad], Mean anomaly M0=M(t0) [rad] at epoch t0 [JD], along with the adjustments of these parameters when the satellite deviates from the planned orbits, which can be used by UE to derive the real-time location of a satellite; (ii) beam information (e.g. number of beams for each satellite, boresight and/or 3 dB bandwidth of each beam) can also be broadcast to UE 602; cell information associated with each satellite or beam can also be broadcast to UE 602 to derive the coverage of a cell; and (iv) rangeToBestCellNTN.

After receiving SIBX 608, as described above, the UE 602 can perform the cell reselection procedure 606. In a first operation, the UE 606 performs measurements on neighbor cells and rank the cells based on R-criterion and identity candidate cells whose R value is within rangeToBestCellNTN of the R value of the highest ranked cell, i.e., Cell #2 508 and Cell #3 512. This initial ranking can be in accordance with conventional techniques. Next, based on the association between satellite/beam and the cell information, the UE 602 can identify coverage of each cell. The UE 602 can then estimate the remaining valid time of each cell. Finally, the UE 602 will perform cell reselection to the cell (i.e., Cell #3 512) with a longest valid time (i.e., T3, as compared with T1 or T2).

### Example Scenario 4

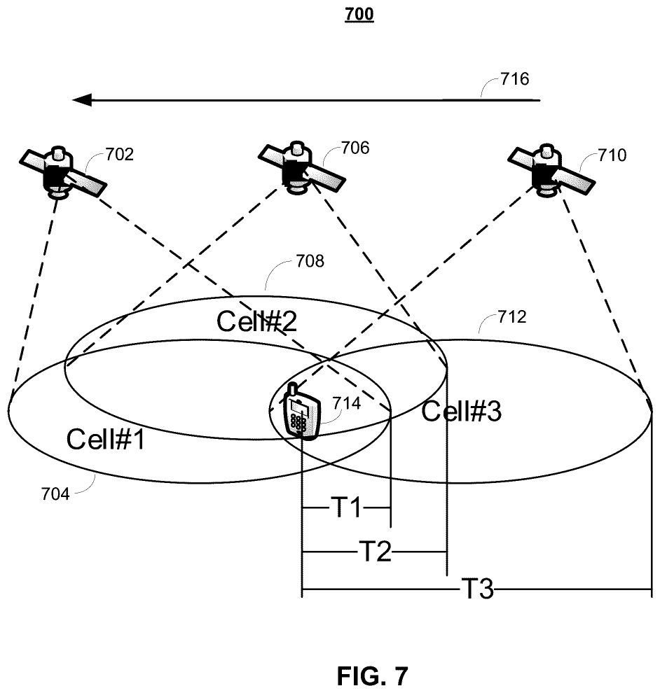

FIG. 7 illustrates an NTN 700 for in which yet another cell reselection method may be performed by a UE 714, in accordance with some embodiments of the present disclosure. NTN 700 comprises satellite 702, satellite 706 and satellite 710 that respectively transmit to Cell #1 704, Cell #2 708 and Cell #3 712. As illustrated, UE 714 is located within the boundaries of Cell #1 704, Cell #2 708 and Cell #3 712. It can be assumed that UE 714 is now camping on Cell #1 704 and is moving toward the edge of Cell #1 704, in which case a reselection to connect to either Cell #2 708 or Cell #3 710 should be considered. As illustrated, T1 represents a valid time of operation for UE 714 in Cell #1 704, T2 represents a valid time of operation for UE 714 in Cell #2 708, and T3 represents a valid time or operation for UE 714 in Cell #3 712. Per FIG. 7, T3 represents the longest valid time of operation. Arrow 716 indicates a direction that the satellites are moving.

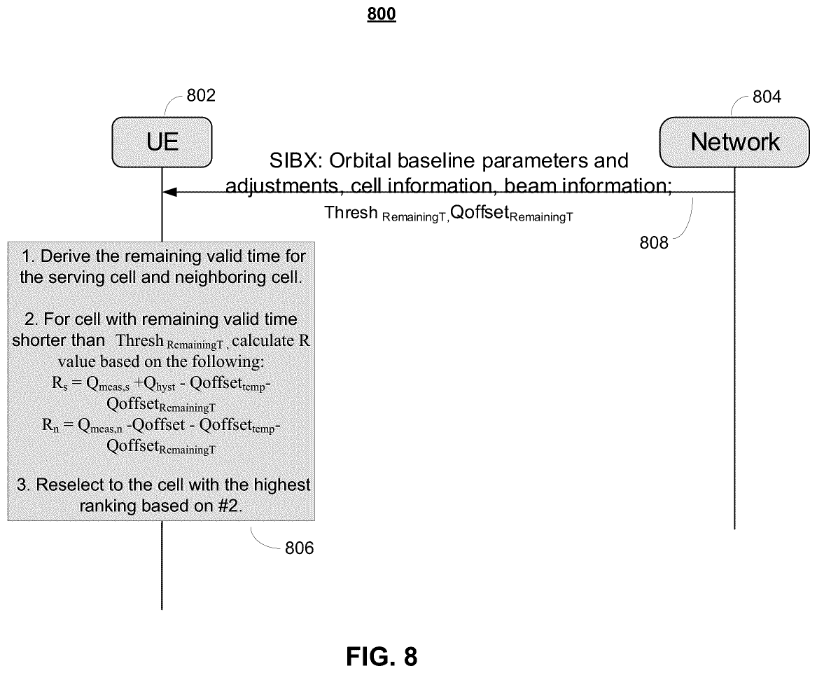

FIG. 8 illustrates a diagram of a method 800 implemented between a UE 802 and a network node 804 (e.g., a satellite) for performing a cell reselection procedure 806, in accordance with some embodiments of the present disclosure. As illustrated, while camping on Cell #1 704, the UE 802 receives ephemeris and configuration information (i.e., orbital baseline parameters and adjustments) via message SIBX 808 transmitted by the network node 804. In some embodiments, message SIBX can contain one or more of the following: (i) orbital baseline parameters contain the Keplerian Orbit Elements (a, e, ω, Ω, i, M0), including Semi-major axis a [m], Eccentricity e Argument of periapsis ω [rad] , Longitude of ascending node Ω [rad], Inclination i [rad], Mean anomaly M0=M(t0) [rad] at epoch t0 [JD], along with the adjustments of these parameters when the satellite deviates from the planned orbits, which can be used by UE to derive the real-time location of a satellite; (ii) beam information (e.g. number of beams for each satellite, boresight and/or 3 dB bandwidth of each beam) than can be broadcast to UE 802; (iii) cell information associated with each satellite or beam is also broadcast to UE to derive the coverage of a cell; and (iv) Thresh_{RemainingT} (e.g., T2<Thresh_{RemainingT}<T3) and Qoffset_{RemainingT} (with a positive value).

After receiving the SIBX message 808, the UE 802 can perform the cell reselection procedure 806. In a first operation, the UE 802 performs measurements on the serving and neighbor cells. For cells with equal reselection priority (e.g., Cell #1 704, Cell #2 708 and Cell #3 712), the UE 802 can estimate the remaining valid time of the cells and determine whether the remaining valid time for Cell #1 702 and Cell #2 708 can be shorter than Thresh_{RemainingT}. Next, for cells with remaining valid times shorter than the threshold, the UE will apply the following adjusted R-criterion (with Qoffset_{RemainingT} used) in a calculation to reduce the R value of such cells:

Rₛ=Q_{meas,s}+Q_{hyst}−Qoffsetₜₑₘₚ−Qoffset_{RemainingT} (For serving Cell #1 704)

Rₙ=Q_{meas,n}−Qoffset−Qoffsetₜₑₘₚ−Qoffset_{RemainingT} (For neighbour Cell #2 708)

Since the remaining valid time of Cell #3 712 can be longer than the threshold, the following R-criterion can be used so that the R value is not reduced by the new offset and is provided by the following: Rₙ=Q_{meas,n}−Qoffset−Qoffsetₜₑₘₚ

Finally, for cells with equal reselection priority, UE 802 can perform cell reselection to the highest ranked cell (ranked based on the R value as calculated above).

### Example Scenario 5

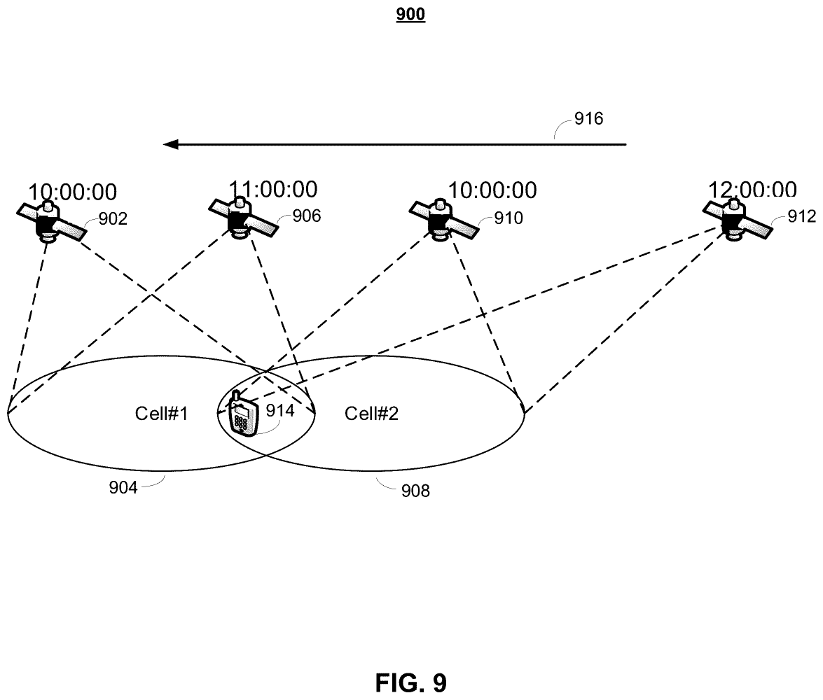

FIG. 9 illustrates an NTN 900 in which another cell reselection method can be performed by a UE 914, in accordance with some embodiments of the present disclosure. NTN 900 comprises satellite 902, satellite 906, satellite 910 and satellite 912 that respectively transmit to Cell #1 904 and Cell #2 908. As illustrated, UE 914 is located within the boundaries of Cell #1 904, and Cell #2 908. Arrow 916 indicates a direction that the satellites are moving.

As shown in FIG. 9, UE 914 can be camping on Cell #1 904. Cell #1 904 is covered by satellite 904 at time 10:00:00, while satellite 906 can take over Cell #1 904 at time 11:00:00 and the cell ID can change even though the cell coverage is essentially the same and UE 914 can consider it as another cell. Thus, the serving time of Cell #1 902 is 1 hour in this scenario. Similarly, Cell #2 is covered by satellite 910 at 10:00:00 until satellite 912 takes over the coverage area at 12:00:00, at which point a new cell ID is established. Thus, the serving time of Cell #2 908 is 2 hours in this scenario. For some embodiments, the steps for reselection are indicated below.

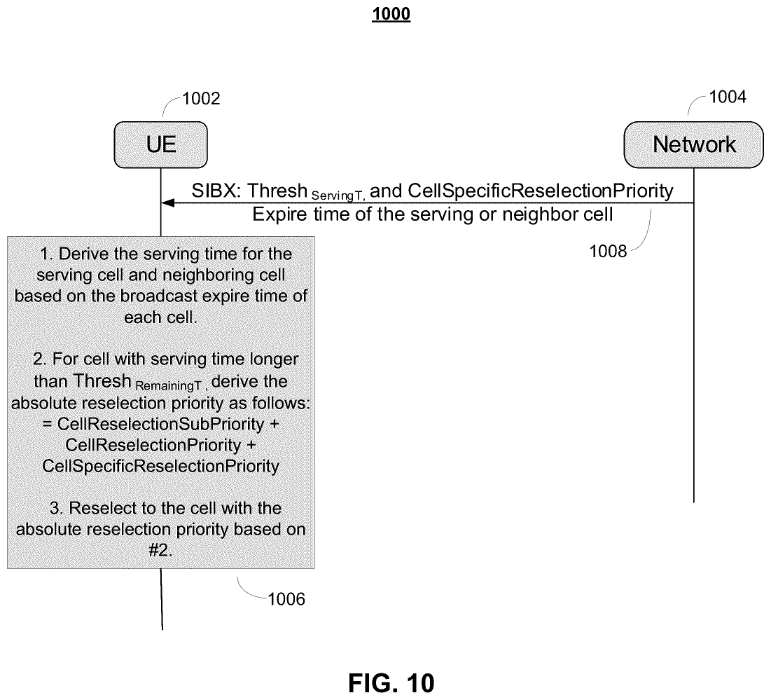

FIG. 10 illustrates a diagram of a method 1000 implemented between a UE 1002 and

a network node 1004 (e.g., a satellite) for performing a cell reselection procedure 1006, in accordance with some embodiments of the present disclosure. As illustrated, network 1004 transmits message SIBX 1008. Message SIBX 1008 represents system information comprising Thresh_{ServingT}, CellSpecificReselectionPriority and Expire time of the serving or neighbor cell.

As shown in FIG. 10, while camping on Cell #1 904, UE 1002, can receive the Thresh_{ServingT} (e.g. 1.5 hours), CellSpecificReselectionPriority (e.g., 2) and the expire time of the serving cell (e.g., 11:00:00 for Cell #1 904) and neighbor cell (12:00:00 for Cell #2 908) via SIBX broadcast from Cell #1 904.

After receiving SIBX 1008, the UE 1002 can perform the reselection procedure 1006. In a first step, the UE 1002 can derive the serving times for the serving Cell #1 904 and neighbor Cell #2 908) based on the broadcast expire time of each cell to determine whether the serving time of each cell is longer than the Thresh_{ServingT}. Next, for cells with serving times longer than Thresh_{ServingT}, the UE 1002 can apply the CellSpecificReselectionPriority (e.g., 2) to derive the absolute reselection priority for each candidate cell. In some embodiments, the absolute reselection priority is given by:

Absolute Reselection priority=CellReselectionSubPriority+CellReselectionPriority+CellSpecificReselectionPriority

Finally, at operation 3, the UE 1002 can perform cell reselection to the cell having the highest absolute reselection priority value.

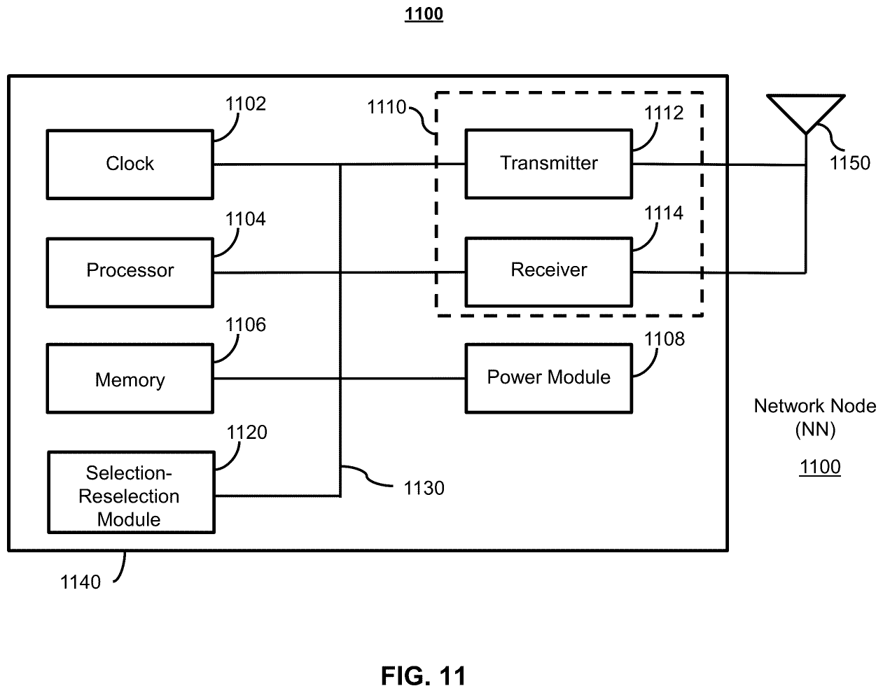

FIG. 11 illustrates a block diagram of a network node (NN) 1100, in accordance with various embodiments of the disclosure. The NN 1100 is an example of a wireless communication device or wireless communication node that can be configured to implement the various methods described herein. In some embodiments, the NN 1100 may be wireless communication node such as a satellite, as described herein. In other embodiments, the NN 1100 may be a wireless communication device such as a user equipment device (UE), as described herein. As shown in FIG. 11, the NN 1100 includes a housing 1140 containing a system clock 1102, a processor 1104, a memory 1106, a transceiver 1110 comprising a transmitter 1112 and receiver 1114, a power module 1108, and a selection/reselection module 1120. The selection/reselection module 1120 can select or reselect a cell for providing cellular communication services to a UE, in accordance with the methods described herein.

In this embodiment, the system clock 1102 provides the timing signals to the processor 1104 for controlling the timing of all operations of the NN 1100. The processor 1104 controls the general operation of the NN 1100 and can include one or more processing circuits or modules such as a central processing unit (CPU) and/or any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable circuits, devices and/or structures that can perform calculations or other manipulations of data.

The memory 1106, which can include both read-only memory (ROM) and random access memory (RAM), can provide instructions and data to the processor 1104. A portion of the memory 1106 can also include non-volatile random access memory (NVRAM). The processor 1104 typically performs logical and arithmetic operations based on program instructions stored within the memory 1106. The instructions (a.k.a., software) stored in the memory 1106 can be executed by the processor 1104 to perform the methods described herein. The processor 1104 and memory 1106 together form a processing system that stores and executes software. As used herein, “software” means any type of instructions, whether referred to as software, firmware, middleware, microcode, etc. which can configure a machine or device to perform one or more desired functions or processes. Instructions can include code (e.g., in source code format, binary code format, executable code format, or any other suitable format of code). The instructions, when executed by the one or more processors, cause the processing system to perform the various functions described herein.

The transceiver 1110, which includes the transmitter 1112 and receiver 1114, allows the NN 1100 to transmit and receive data to and from an external network node (e.g., an UE or AP). An antenna 1150 is typically attached to the housing 1140 and electrically coupled to the transceiver 1110. In various embodiments, the NN 1100 includes (not shown) multiple transmitters, multiple receivers, and multiple transceivers. In some embodiments, the antenna 1150 includes a multi-antenna array that can form a plurality of beams each of which points in a distinct direction in accordance with MIMO beamforming techniques.

The selection/reselection module 1120 may be implemented as part of the processor 1104 programmed to perform the functions herein, or it may be a separate module implemented in hardware, firmware, software or a combination thereof. In accordance with various embodiments, the NN 1100 is a wireless communication node, and the selection/reselection module 1120 and transceiver 1110 are configured to perform the method of FIGS. 2, 4, 6, 8 and 10, as described above. In some embodiments, the selection/reselection module 1120 can be implemented as software (i.e., computer executable instructions) stored in a non-transitory computer-readable medium that when executed by processor 1104, transform the processor 1104 into a special-purpose computer to perform the wireless communication device capability confirmation methods and operations described herein.

The various components and modules discussed above within housing 1140 are coupled together by a bus system 1130. The bus system 1130 can include a data bus and, for example, a power bus, a control signal bus, and/or a status signal bus in addition to the data bus. It is understood that the modules of the NN 1100 can be operatively coupled to one another using any suitable techniques and mediums. It is further understood that additional modules (not shown) may be included in the NN 1100 without departing from the scope of the disclosure.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques.

To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, module, etc. can be configured to perform one or more of the functions described herein. The term “configured to” or “configured for” as used herein with respect to a specified operation or function refers to a processor, device, component, circuit, structure, machine, module, etc. that is physically constructed, programmed and/or arranged to perform the specified operation or function.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A method performed by a wireless communication device, the method comprising:
obtaining configuration information;
based on the configuration information, selecting at least one criterion from among following criteria:
a cell with a shortest distance between a cell center and the wireless communication device,
a cell with a shortest distance between a satellite and the wireless communication device,
a cell with a longest valid time,
a cell with a longest serving time,
a cell with a longest remaining valid time, or
a cell with a longest remaining serving time,
ranking a plurality of candidate cells based at least in part on the selected at least one criterion; and
selecting or reselecting one of the plurality candidate cells having a highest rank among the plurality of candidate cells.

2. The method of claim 1, further comprising:
based on the configuration information, performing at least one of:
determining the plurality of candidate cells for selection or reselection; and
adjusting the ranking of the plurality of candidate cells.

3. The method of claim 2, wherein:
the wireless communication device determines the plurality of candidate cells based on the configuration information; and
the configuration information comprises at least one of:
a range to best cell for a non-terrestrial network (NTN) (Range_{ToBestCellNTN}), wherein only cells having a ranking within Range_{ToBestCellNTN} are selected as candidate cells;
a threshold of remaining valid time of a cell (Thresh_{RemainingVT}), wherein only cells having a remaining valid time greater than or lower than Thresh_{RemainingVT}) are selected as candidate cells; and
a threshold of remaining serving time of a cell (Thresh_{ServingT}), wherein only cells having a remaining serving time greater than or lower than Thresh_{RemainingST}) are selected as candidate cells.

4. The method of claim 2, wherein:
the wireless communication device adjusts the ranking of the plurality of candidate cells based on the configuration information; and
the configuration information comprises a predetermined adjustment value and at least one of:
a threshold of remaining valid time of a cell (Thresh_{RemainingVT}), wherein rankings of cells having a remaining valid time less than Thresh_{RemainingVT} are decreased by the predetermined adjustment value;
a threshold of remaining serving time of a cell (Thresh_{RemainingST}), wherein rankings of cells having a remaining serving time less than Thresh_{RemainingST} are decreased by the predetermined adjustment value;
a threshold of maximum distance to a satellite (Thresh_{DistanceToSat}), wherein rankings of cells whose serving satellites having a distance to the wireless communication device greater than Thresh_{DistanceToSat} are decreased by the predetermined adjustment value; and
a threshold of maximum distance to a cell center (Thresh_{DistanceToCellCenter}), wherein rankings of cells whose cell centers having a distance to the wireless communication device greater than Thresh_{DistanceToCellCenter} are decreased by the predetermined adjustment value.

5. The method of claim 2, wherein the configuration information is broadcast as system information or provided via Radio Resource Control (RRC) signaling.

6. The method of claim 1, further comprising:
obtaining at least one of ephemeris information associated with a plurality of candidate satellites of a non-terrestrial network (NTN) and/or a cell expire time; and
based the at least one of the ephemeris information and/or the cell expire time, calculating a value of the selected at least one criterion.

7. The method of claim 6, wherein the ephemeris information comprises at least one of:
orbital parameters associated with the plurality of candidate satellites, adjustments to the orbital parameters, orbital state vectors associated with the plurality of candidate satellites, cell information associated with the plurality of candidate satellites, beam information associated with the plurality of candidate satellites, an association between the cell information and the orbital parameters and the orbital state vectors, and an association between the cell information and the beam information.

8. The method of claim 7, wherein at least a portion of the ephemeris information is pre-configured in the wireless communication device via Non Access Stratum (NAS) signaling or pre-configured in a Universal Subscriber Identity Module (USIM) contained in the wireless communication device.

9. The method of claim 8, wherein at least a portion of the ephemeris information and the cell expire time is broadcast as system information or provided via Radio Resource Control (RRC) signaling by the NTN.

10. A method performed by a wireless communication device operating in a non-terrestrial network (NTN), the method comprising:
obtaining configuration information associated with a plurality of candidate cells of the NTN, each of the plurality of candidate cells associated with a respective one of a plurality of candidate satellites; and
based on the configuration information, adjusting a ranking of the plurality of candidate cells for cell selection or reselection.

11. The method of claim 10, wherein:
the wireless communication device determines the plurality of candidate cells based on the configuration information; and
the configuration information comprises at least one of:
a range to best cell for the NTN (Range_{ToBestCellNTN}), wherein only cells having a ranking within Range_{ToBestCellNTN} are selected as candidate cells;
a threshold of remaining valid time of a cell (Thresh_{RemainingVT}), wherein only cells having a remaining valid time greater than Thresh_{RemainingVT}) are selected as candidate cells; and
a threshold of remaining serving time of a cell (Thresh_{ServingT}), wherein only cells having a remaining serving time greater than Thresh_{RemainingST}) are selected as candidate cells.

12. The method of claim 10, wherein:
the wireless communication device adjusts the ranking of the plurality of candidate cells based on the configuration information; and
the configuration information comprises a predetermined adjustment value and at least one of:
a threshold of remaining valid time of a cell (Thresh_{RemainingVT}), wherein rankings of cells having a remaining valid time less than Thresh_{RemainingVT} are decreased by the predetermined adjustment value;
a threshold of remaining serving time of a cell (Thresh_{RemainingST}), wherein rankings of cells having a remaining serving time less than Thresh_{RemainingST} are decreased by the predetermined adjustment value;
a threshold of maximum distance to a satellite (Thresh_{DistanceToSat}), wherein rankings of cells associated with respective satellites having a distance to the wireless communication device greater than Thresh_{DistanceToSat} are decreased by the predetermined adjustment value; and
a threshold of maximum distance to a cell center (Thresh_{DistanceToCellCenter}), wherein rankings of cells whose cell centers have a distance to the wireless communication device greater than Thresh_{DistanceToCellCenter} are decreased by the predetermined adjustment value.

13. The method of claim 10, wherein the configuration information is broadcast as system information or a Radio Resource Control (RRC) signal by the NTN.

14. The method of claim 10, further comprising:
obtaining at least one of ephemeris information associated with the plurality of candidate satellites and a cell expire time;
based on the at least one of the ephemeris information and/or the cell expire time, determining at least one criterion from among the following criteria:
a cell with a shortest distance between a cell center and the wireless communication device;
a cell with a shortest distance between a satellite and the wireless communication device;
a cell with a longest valid time;
a cell with a longest serving time;
a cell with a longest remaining valid time; and
a cell with a longest remaining serving time;
ranking the plurality of candidate cells based at least in part on the at least one criterion and the configuration information; and
selecting or reselecting one of the plurality candidate cells having a highest rank among the plurality of candidate cells.

15. The method of claim 14, wherein the ephemeris information comprises at least one of:
orbital parameters associated with the plurality of candidate satellites, adjustments to the orbital parameters, orbital state vectors associated with the plurality of candidate satellites, cell information associated with the plurality of candidate satellites, beam information associated with the plurality of candidate satellites, an association between the cell information and the orbital parameters and the orbital state vectors, and an association between the cell information and the beam information.

16. The method of claim 15, wherein at least a portion of the ephemeris information is pre-configured in the UE via Non Access Stratum (NAS) signaling or pre-configured in a Universal Subscriber Identity Module (USIM) contained in the wireless communication device.

17. The method of claim 16, wherein at least a portion of the ephemeris information and the cell expire time are broadcast as system information or provided via Radio Resource Control (RRC) signaling by the NTN.

18. The method of claim 14, wherein the at least one criterion is selected based on the configuration information, and the selected at least one criterion is determined based on at least one of the ephemeris information and the cell expire time.

19. A non-transitory machine-readable media, having instructions stored on the machine-readable media, the instructions configured to, when executed, cause a machine to:
obtain configuration information;
based on the configuration information, select at least one criterion from among following criteria:
a cell with a shortest distance between a cell center and the wireless communication device,
a cell with a shortest distance between a satellite and the wireless communication device,
a cell with a longest valid time,
a cell with a longest serving time,
a cell with a longest remaining valid time, or
a cell with a longest remaining serving time;
rank a plurality of candidate cells based at least in part on the selected at least one criterion; and
select or reselect one of the plurality candidate cells having a highest rank among the plurality of candidate cells.

20. A wireless communication device, comprising:
a memory operable to store computer-readable instructions; and
a processor circuitry operable to read the computer-readable instructions, the processor circuitry when executing the computer-readable instructions is configured to:
obtain configuration information;
based on the configuration information, select at least one criterion from among following criteria:
a cell with a shortest distance between a cell center and the wireless communication device,
a cell with a shortest distance between a satellite and the wireless communication device,
a cell with a longest valid time,
a cell with a longest serving time,
a cell with a longest remaining valid time, and
a cell with a longest remaining serving time;
rank a plurality of candidate cells based at least in part on the selected at least one criterion; and
select or reselect one of the plurality candidate cells having a highest rank among the plurality of candidate cells.

21-37. (canceled)
